(19) United States
(12) Patent Application Publication
(10) Pub. No.: US 2025/0369847 A1
(43) Pub. Date: Dec. 4, 2025

(54) ESTIMATION SYSTEM AND ESTIMATION METHOD

(71) Applicant: Panasonic Intellectual Property Management Co., Ltd., Osaka (JP)

(72) Inventors: Yuya HOMMA, Osaka (JP); Mototaka YOSHIOKA, Osaka (JP)

(21) Appl. No.: 18/875,834

(22) PCT Filed: Apr. 17, 2023
(86) PCT No.: PCT/JP2023/015328

§ 371 Date: Dec. 17, 2024

(30) Foreign Application Priority Data
Jul. 13, 2022 (JP) 2022-112512

(51) Int. Cl. G01N 3/42; G01N 3/06; G01N 3/08; G06T 7/246

(52) U.S. Cl. CPC G01N 3/42; G01N 3/068; G01N 3/08; G06T 7/248; G06T 2207/10016

(57) ABSTRACT

An estimation system includes: an imager that captures images of a target in which an object appears in a background; an applier that applies force to the target; a calculator that calculates an amount of deformation of the target when the force is applied to the target, based on a change in the target with respect to the object in the images captured by the imager, the change resulting from the force being applied to the target; and an estimator that estimates, based on the amount of deformation calculated, information on a degree of flexibility of the target.

### TECHNICAL FIELD

The present disclosure relates to an estimation system and an estimation method.

### BACKGROUND ART

Patent Literature (PTL 1) describes a device that derives the degree of flexibility of a target and gripping force for gripping the target, using a tactile sensor inside a gripper attached to the tip of a manipulator.

### CITATION LIST

### Patent Literature

[PTL 1] Japanese Unexamined Patent Application Publication No. H8-323678

### SUMMARY OF INVENTION

### Technical Problem

However, with the device described in PTL 1, when estimating information on the degree of flexibility of a target, such as the degree of flexibility of the target and gripping force, using the tactile sensor, teaching of the material, size, and so on, of the target has to be performed in advance. Furthermore, in general, a tactile sensor is expensive, and thus there is the problem that the method which uses a tactile sensor is costly.

In view of this, the present disclosure provides an estimation system that can estimate information on the degree of flexibility of a target, by using an image sensor.

### Solution to Problem

An estimation system according to an aspect of the present disclosure includes: an imager that captures images of a target in which an object appears in a background; an applier that applies force to the target; a calculator that calculates an amount of deformation of the target when the force is applied to the target, based on a change in the target with respect to the object in the images captured by the imager, the change resulting from the force being applied to the target; and an estimator that estimates, based on the amount of deformation calculated, information on a degree of flexibility of the target.

An estimation method according to an aspect of the present disclosure includes: capturing images of a target in which an object appears in a background; applying force to the target; calculating an amount of deformation of the target when the force is applied to the target, based on a change in the target with respect to the object in the images captured in the capturing, the change resulting from the force being applied to the target; and estimating, based on the amount of deformation calculated, information on a degree of flexibility of the target.

### Advantageous Effects of Invention

The estimation system, and the like, according to an aspect of the present disclosure can estimate information on the degree of flexibility of a target, by using an image sensor.

### BRIEF DESCRIPTION OF DRAWINGS

FIG. 1 is an overall configuration diagram illustrating an example of an estimation system according to an embodiment.

FIG. 2 is a block diagram illustrating an example of the estimation system according to the embodiment.

FIG. 3 is a diagram for describing a method for measuring an amount of deformation of a target.

FIG. 4 is a diagram illustrating an example of a database indicating the relationship between the amount of deformation and information on the degree of flexibility.

FIG. 5 is a diagram illustrating an example of a method for applying force to the target.

FIG. 6 is a diagram illustrating an example of a method for applying force to the target.

FIG. 7 is a diagram illustrating an example of a method for applying force to the target.

FIG. 8 is a diagram illustrating an example of a method for applying force to the target.

FIG. 9 is a diagram for describing a method for calculating the amount of deformation of the target each time the object appearing in the background changes.

FIG. 10 is a diagram for describing a method for calculating the amount of deformation of the target each time the method for applying force to the target changes.

FIG. 11 is a diagram illustrating an example of controlling the position of the object appearing in the background of the target.

FIG. 12 is a diagram illustrating another example of an object appearing in the background.

FIG. 13 is a diagram illustrating another example of an object appearing in the background.

FIG. 14 is a diagram for describing the obtaining of size information of an object by using a WEB search.

FIG. 15 is a flowchart illustrating an example of an estimation method according to another embodiment.

### DESCRIPTION OF EMBODIMENTS

Hereinafter, embodiments will be described in detail with reference to the Drawings.

It should be noted that each of the embodiments described below shows a general or specific example. The numerical values, shapes, materials, elements, the arrangement and connection of the elements, etc., indicated in the following embodiments are mere examples, and thus are not intended to limit the present disclosure.

### Embodiment

Hereinafter, estimation system 1 according to an embodiment will be described.

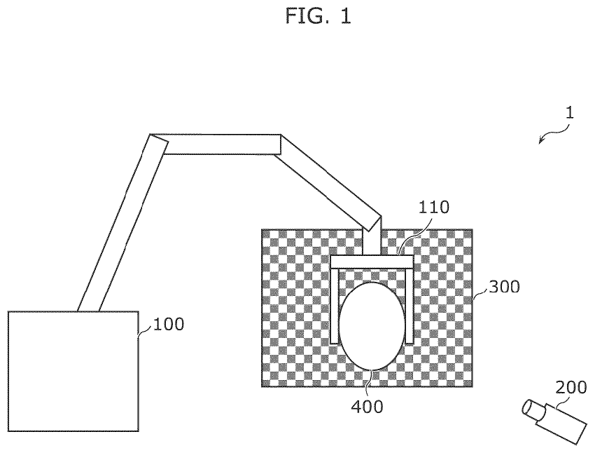

FIG. 1 is an overall configuration diagram illustrating an example of estimation system 1 according to an embodiment. Note that FIG. 1 also illustrates target 400 of which information on a degree of flexibility is to be estimated by estimation system 1.

Estimation system 1 is a system for estimating information on the degree of flexibility of target 400. The information on the degree of flexibility of target 400 includes the degree of flexibility of target 400 or a gripping force for gripping target 400. The gripping force is considered an example of the information on the degree of flexibility of target 400 because target 400 is gripped by a gripping force commensurate with the degree of flexibility of target 400 when target 400 is gripped using a manipulator or the like.

As illustrated in FIG. 1, estimation system 1 includes robot 100, imager 200, and object 300. Note that object 300 need not be an element of estimation system 1.

Robot 100 is a device for estimating information on the degree of flexibility of target 400 and, for example, includes manipulator 110. Robot 100 applies force to target 400 by controlling manipulator 110 to grip target 400. Robot 100 applies the force to target 400 in a vicinity of object 300 or, specifically, at a position where object 300 appears in a background of target 400 in an image captured by imager 200. Note that Robot 100 need not include manipulator 110 and may include a table or the like on which target 400 is placed.

Object 300 is, for example, a pattern image having a repetitive pattern. In FIG. 1, a pattern image having a checkerboard pattern is illustrated as object 300. In a pattern image having a checkerboard pattern such as that illustrated in FIG. 1, a size of each repeated grid is constant and estimation system 1 stores a distance of one side of each grid in advance. Note that object 300 need not be such a pattern image and may be any object present in daily life. Specifically, object 300 may be a window, a door, a floor having a repetitive pattern (for example, a tatami mat), or the like. For example, estimation system 1 stores a distance between two arbitrary points in object 300 in advance. For example, when estimation system 1 stores, in advance, a distance of one side of a rectangular window or door (for example, a distance between the vertices of the window or door), a distance of repeated portions of a floor with a repetitive pattern (for example, a distance between seams of a tatami mat), or the like, estimation system 1 can treat such a window, door, or floor as object 300.

Imager 200 captures images of target 400 in which object 300 appears in the background. For example, robot 100 and imager 200 may be communicably connected and robot 100 may control imager 200. Alternatively, robot 100 may include imager 200. In other words, robot 100 and imager 200 may be integrated with each other. For example, imager 200 may be connected to an arm portion of robot 100 and a positional relationship between object 300 and target 400 may be determined by moving the arm to an appropriate position. In this case, estimation system 1 may be an estimation apparatus constructed by integrating robot 100 and imager 200.

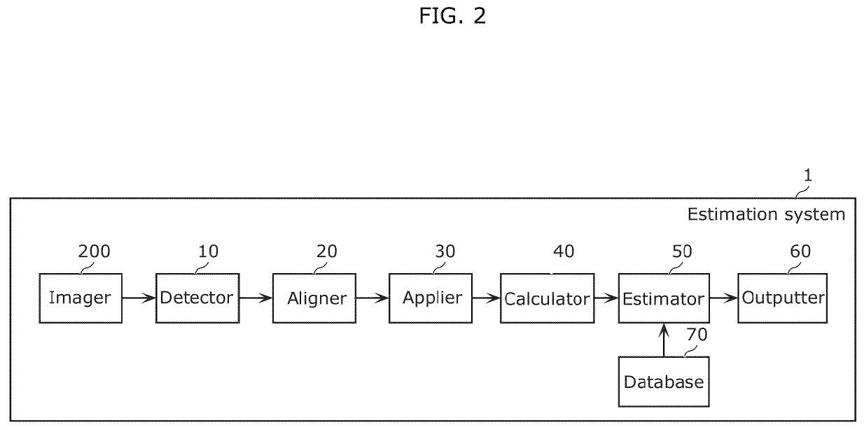

FIG. 2 is a block diagram illustrating an example of estimation system 1 according to the embodiment.

Estimation system 1 includes imager 200, detector 10, aligner 20, applier 30, calculator 40, estimator 50, outputter 60, and database 70. For example, detector 10, aligner 20, applier 30, calculator 40, estimator 50, outputter 60, and database 70 are included in robot 100. Estimation system 1 (for example, robot 100 included in estimation system 1) is a computer including a processor and a memory. The memory is a ROM (Read Only Memory), a RAM (Random Access Memory), and the like and can store a program to be executed by the processor. Detector 10, aligner 20, applier 30, calculator 40, estimator 50, and outputter 60 are realized by the processor that executes programs stored in the memory. Note that the memory storing programs and the memory storing database 70 may be different memories.

Note that elements constituting estimation system 1 may be arranged in a distributed manner. For example, estimation system 1 may be a system including a plurality of servers and elements constituting estimation system 1 may be arranged at the plurality of servers in a distributed manner.

Detector 10 detects object 300 that is suitable for calculating an amount of deformation (details will be described later) of target 400. Specifically, object 300 that is suitable for calculating the amount of deformation of target 400 is detected in an image captured by imager 200. For example, when detector 10 is unable to detect object 300 suitable for calculating the amount of deformation of target 400 such as the pattern image, the door, the window, or the floor described above, estimation system 1 may move a position of target 400 and control imager 200 so as to change a capturing area of imager 200 until detector 10 successfully detects object 300. Accordingly, target 400 in which object 300 appears in the background can be captured. Alternatively, estimation system 1 may control a position of object 300 in order to capture an image of target 400 in which object 300 appears in the background.

For example, detector 10 may detect an object in a color that differs from target 400 as object 300. For example, when a color of target 400 is white, white object 300 is not detected and object 300 that is not white is detected. When the color of target 400 and the color of object 300 are the same kind of color, target 400 and object 300 that appear in images are hard to distinguish, and thus calculating the amount of deformation of target 400 becomes difficult. In contrast, when the color of target 400 and the color of object 300 are different, target 400 and object 300 that appear in images are easy to distinguish, and thus calculating the amount of deformation of target 400 becomes easy.

Aligner 20 aligns an arbitrary point on target 400 and a reference point on object 300 in images captured by imager 200. Details of aligner 20 will be described later.

Applier 30 applies the force to target 400. For example, applier 30 applies the force to target 400 by controlling manipulator 110 to grip target 400. Accordingly, target 400 can be deformed.

Calculator 40 calculates the amount of deformation of target 400 when the force is applied to target 400 based on a change in target 400 with respect to object 300 in the images captured by imager 200, the change resulting from the force being applied to target 400. In other words, calculator 40 calculates the amount of deformation of target 400 when the force is applied to target 400 based on how much a contour or the like of target 400 with respect to object 300 in an image captured before the force is applied to target 400 has changed in an image captured when the force is applied to target 400.

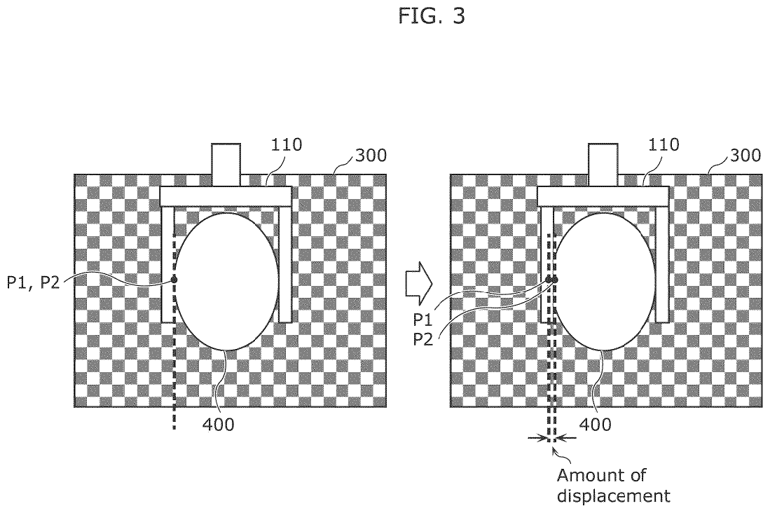

Specifically, calculator 40 calculates the amount of deformation of target 400 when the force is applied to target 400 based on an amount of displacement of an arbitrary point of target 400 in an image captured by imager 200 from a reference point of object 300, the displacement resulting from the force being applied to target 400. This will be described with reference to FIG. 3, together with a specific example of alignment of an arbitrary point on target 400 and a reference point on object 300 in an image captured by imager 200.

FIG. 3 is a diagram for describing a method for measuring the amount of deformation of target 400. An image captured before the force is applied to target 400 is illustrated on a left side of FIG. 3 and an image captured when the force is applied to target 400 is illustrated on a right side of FIG. 3.

First, as illustrated on the left side of FIG. 3, aligner 20 aligns arbitrary point P2 on target 400 and reference point P1 on object 300 in an image captured by imager 200. In this case, a point where manipulator 110 and target 400 come into contact with each other is used as point P2. In addition, a border between one grid and the next of object 300 (for example, a pattern image having a checkerboard pattern) is used as reference point P1. Furthermore, in order to make the amount of deformation of target 400 easy to calculate, aligner 20 performs alignment so that a direction in which the force is applied to target 400 (in this case, a left-right direction of a paper surface of FIG. 3) and a direction in which the grids are lined up coincide with each other.

Imager 200 captures target 400 in a state where the alignment described above has been performed and, subsequently, applier 30 applies the force to target 400 and imager 200 captures target 400 in a state where the force has been applied to target 400. Accordingly, images illustrated on the left side and the right side of FIG. 3 are respectively obtained.

As illustrated in FIG. 3, due to the application of the force to target 400, target 400 deforms and the position of point P2 having been aligned with reference point P1 changes. Based on the amount of displacement of point P2 from reference point P1, calculator 40 calculates the amount of deformation of target 400 when the force is applied to target 400. For example, calculator 40 calculates the amount of deformation of target 400 by comparing a distance of one side of one grid in the checkerboard pattern with the amount of displacement of point P2 from reference point P1. Note that, as described above, object 300 may be a door, a window, a floor, or the like and calculator 40 can calculate the amount of deformation of target 400 by comparing an arbitrary distance in the door, the window, the floor, or the like with the amount of displacement of point P2 from reference point P1.

Estimator 50 estimates, based on the calculated amount of deformation of target 400, information on the degree of flexibility of target 400. For example, estimator 50 estimates the information on the degree of flexibility of target 400 by comparing the amount of deformation calculated with database 70 indicating a relationship between the amount of deformation and the information on the degree of flexibility.

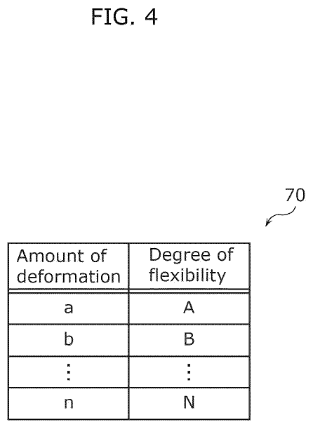

FIG. 4 is a diagram illustrating an example of database 70 indicating the relationship between the amount of deformation and the information on the degree of flexibility. FIG. 4 illustrates database 70 indicating the relationship between the amount of deformation and the degree of flexibility.

For example, database 70 indicating a relationship between the amount of deformation and the degree of flexibility when the force is applied to arbitrary target 400 is created and stored in estimation system 1. Note that database 70 indicating a relationship between the amount of deformation and the gripping force when the force is applied to arbitrary target 400 may be created and stored in estimation system 1. Accordingly, the information on the degree of flexibility of target 400 can be easily estimated. For example, when the calculated amount of deformation of target 400 is a value between a and b, the degree of flexibility of target 400 can be estimated to be a value between A and B.

In addition, outputter 60 outputs estimated information on the degree of flexibility of target 400. For example, outputter 60 may output the degree of flexibility of target 400 to a higher-order system of estimation system 1. Furthermore, outputter 60 may output a gripping force of target 400 to a device that handles target 400 by gripping target 400 or the like.

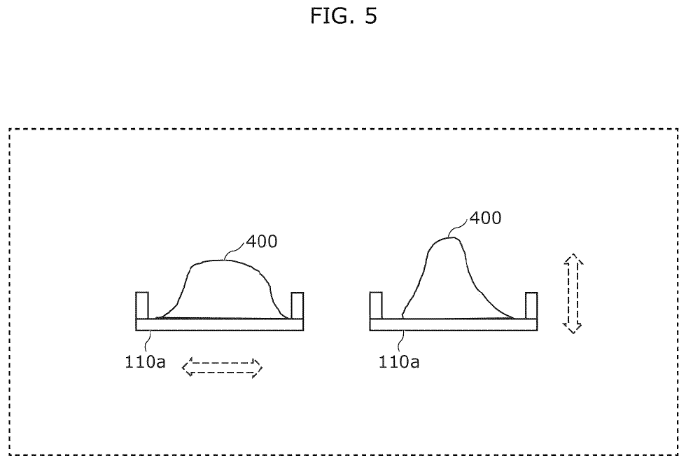

Note that besides gripping target 400, applier 30 may apply the force to target 400 by shaking target 400, rotating target 400, tilting target 400, or blowing air onto target 400. This will be described with reference to FIGS. 5 to 8.

FIGS. 5 to 8 are diagrams illustrating examples of a method for applying the force to target 400.

FIG. 5 is a diagram illustrating a method for applying the force to target 400 by shaking target 400.

For example, when target 400 is a viscous object that cannot be gripped, applier 30 may apply the force to target 400 by placing target 400 on table 110a or the like and shaking target 400 as illustrated in FIG. 5. For example, applier 30 may shake target 400 in a horizontal direction as illustrated on a left side of FIG. 5 or shake target 400 in a vertical direction. Even in this case, target 400 can be deformed and the amount of deformation of target 400 can be calculated.

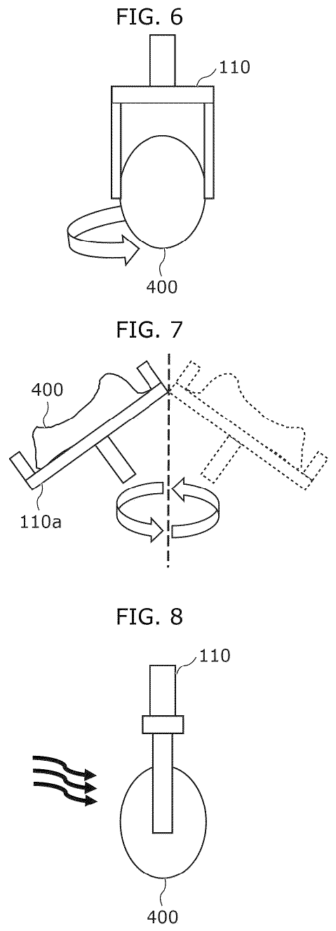

FIG. 6 is a diagram illustrating a method for applying the force to target 400 by rotating target 400.

For example, when target 400 is a partially liquefied solid, applier 30 may apply the force to target 400 by rotating (autorotating) target 400 being fixed by manipulator 110 or the like as illustrated in FIG. 6. Even in this case, target 400 can be deformed and the amount of deformation of target 400 can be calculated.

FIG. 7 is a diagram illustrating a method for applying the force to target 400 by tilting target 400. In addition, FIG. 7 also illustrates a method for applying the force to target 400 by rotating target 400 around an origin while tilting target 400.

For example, when target 400 is a viscous object that cannot be gripped, applier 30 may apply the force to target 400 by placing target 400 on table 110a or the like and tilting target 400 as illustrated in FIG. 7. Alternatively, applier 30 may apply the force to target 400 by further rotating target 400 around an origin while tilting target 400. In addition, although not illustrated, applier 30 may apply the force to target 400 by rotating target 400 like the infinity symbol. Even in these cases, target 400 can be deformed and the amount of deformation of target 400 can be calculated.

FIG. 8 is a diagram illustrating a method for applying the force to target 400 by blowing air onto target 400.

For example, when target 400 is a partially liquefied solid, applier 30 may apply the force to target 400 by blowing air onto target 400 being fixed by manipulator 110 or the like as illustrated in FIG. 8. Even in this case, target 400 can be deformed and the amount of deformation of target 400 can be calculated.

In addition, although not illustrated, applier 30 may apply the force to target 400 by pushing target 400 (for example, against table 110a or the like).

Note that estimator 50 may estimate the information on the degree of flexibility of target 400 further based on gloss of target 400. Since the degree of flexibility of target 400 can be estimated to some extent according to the gloss of target 400, by taking the gloss of target 400 into consideration, the information on the degree of flexibility of target 400 can be estimated more accurately.

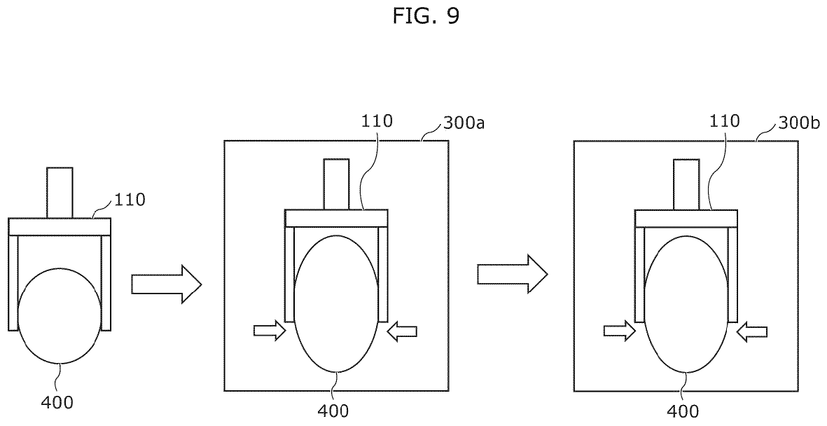

In addition, calculator 40 may calculate the amount of deformation of target 400 every time an image of target 400 in which different object 300 appears in the background is captured by imager 200, and estimator 50 may estimate the information on the degree of flexibility of target 400 based on the amount of deformation of target 400 calculated every time an image of target 400 in which different object 300 appears in the background is captured by imager 200. This point will be described with reference to FIG. 9.

FIG. 9 is a diagram for describing a method for calculating the amount of deformation of target 400 each time object 300 appearing in the background changes.

Calculator 40 calculates the amount of deformation of target 400 using an image obtained by capturing target 400 with object 300a appearing in the background as illustrated at center of FIG. 9 and calculates the amount of deformation of target 400 also using an image obtained by capturing target 400 with object 300b that differs from object 300a appearing in the background as illustrated on right side of FIG. 9. Note that calculator 40 may further calculate the amount of deformation of target 400 using images obtained by capturing target 400 with different objects appearing in the images. In addition, estimator 50 estimates, based on each calculated amount of deformation, information on the degree of flexibility of target 400. For example, estimator 50 may estimate information on the degree of flexibility of target 400 by using a representative value such as a mean or a median of each amount of deformation or by excluding an outlier.

Depending on the material of target 400, there are cases where it is difficult to observe a change in target 400 with respect to object 300, and thus the amount of deformation of target 400 cannot be calculated correctly. However, by calculating the amount of deformation of target 400 each time object 300 appearing in the background is changed, the information on the degree of flexibility of target 400 can be estimated more accurately.

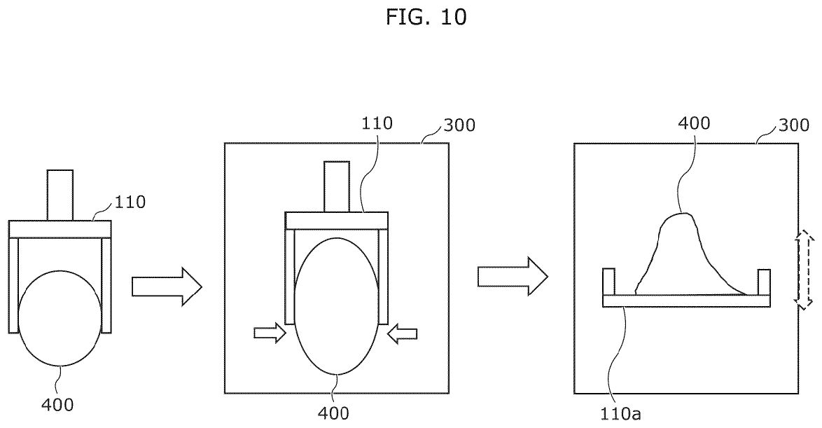

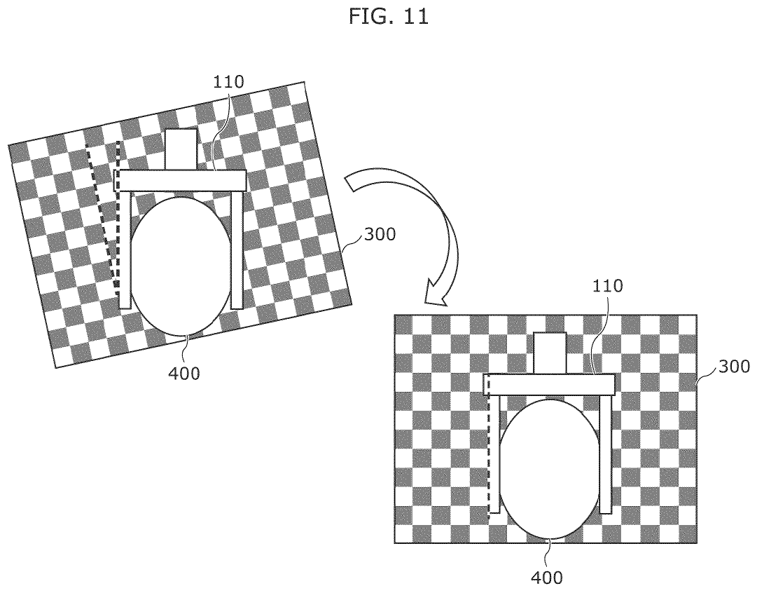

In addition, calculator 40 may calculate the amount of deformation of target 400 every time the force is applied to target 400 by applier 30 using a different method, and estimator 50 may estimate the information on the degree of flexibility of target 400 based on the amount of deformation of target 400 calculated every time the force is applied to target 400 by applier 30 using a different method. This point will be described with reference to FIG. 10.

FIG. 10 is a diagram for describing a method for calculating the amount of deformation of target 400 each time the method for applying the force to target 400 is changed.

Calculator 40 calculates the amount of deformation of target 400 when the force is applied to target 400 by gripping target 400 as illustrated at center of FIG. 10 and calculates the amount of deformation of target 400 when the force is applied to target 400 by shaking target 400 as illustrated on right side of FIG. 10. Note that calculator 40 may further calculate the amount of deformation of target 400 when the force is applied to target 400 by different methods. In addition, estimator 50 estimates, based on each amount of deformation calculated in this manner, information on the degree of flexibility of target 400. For example, estimator 50 may estimate information on the degree of flexibility of target 400 by using a representative value such as a mean or a median of each amount of deformation or by excluding an outlier.

Depending on the material of target 400, there are cases where the method of applying the force is not suitable, and thus the amount of deformation of target 400 cannot be calculated correctly. However, by calculating the amount of deformation of target 400 each time the method of applying the force to target 400 is changed, the information on the degree of flexibility of target 400 can be estimated more accurately.

In addition, calculator 40 may calculate the amount of deformation of target 400 every time an image of target 400 is captured by imager 200 so that a distance between target 400 and object 300 differs, and estimator 50 may estimate the information on the degree of flexibility of target 400 based on the amount of deformation of target 400 calculated every time an image of target 400 is captured by imager 200 so that the distance between target 400 and object 300 differs.

Depending on the distance of target 400 from object 300, there are cases where it is difficult to observe a change in target 400 with respect to object 300, and thus the amount of deformation of target 400 cannot be calculated correctly. However, by calculating the amount of deformation of target 400 each time the distance between target 400 and object 300 is changed, the information on the degree of flexibility of target 400 can be estimated more accurately.

Note that calculator 40 may calculate the amount of deformation of target 400 every time conditions are changed among various conditions such as changing object 300 appearing in the background, changing the method for applying the force to target 400, and changing the distance between target 400 and object 300.

In addition, a position or an orientation of object 300 appearing in the background of target 400 may be controlled. This point will be described with reference to FIG. 11.

FIG. 11 is a diagram illustrating an example of controlling an orientation of object 300 appearing in the background of target 400.

As illustrated in FIG. 11, when a direction in which the force is applied to target 400 (in this case, a left-right direction of a paper surface in FIG. 11) and a direction in which the grids of object 300 (a pattern image with a checkerboard pattern) are lined up do not coincide with each other, estimation system 1 may rotate the orientation of object 300. Accordingly, calculating the amount of deformation of target 400 becomes easy.

As described above, the information on the degree of flexibility of target 400 can be estimated from the amount of deformation of target 400 when the force is applied to target 400 in images captured by imager 200. Specifically, by using the images obtained by capturing target 400 in which object 300 appears in the background, the amount of deformation of target 400 can be calculated and information on the degree of flexibility of target 400 can be estimated without using a tactile sensor by using an image sensor. Since a tactile sensor is not used, cost-reduction becomes possible. In addition, since teaching becomes unnecessary, information on the degree of flexibility of target 400 can be estimated without teaching.

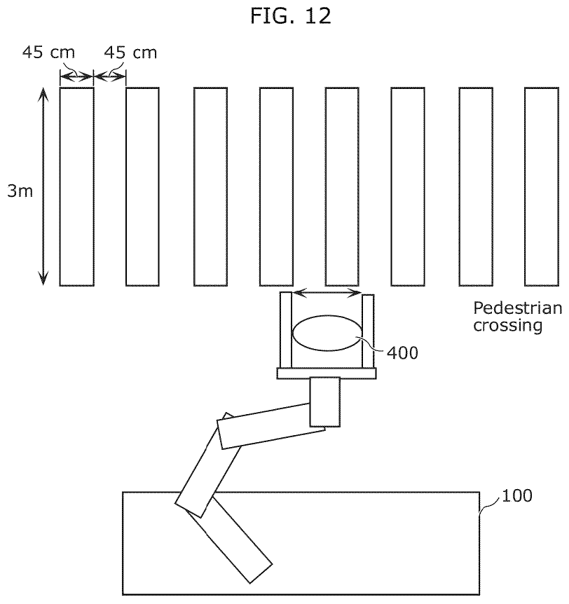

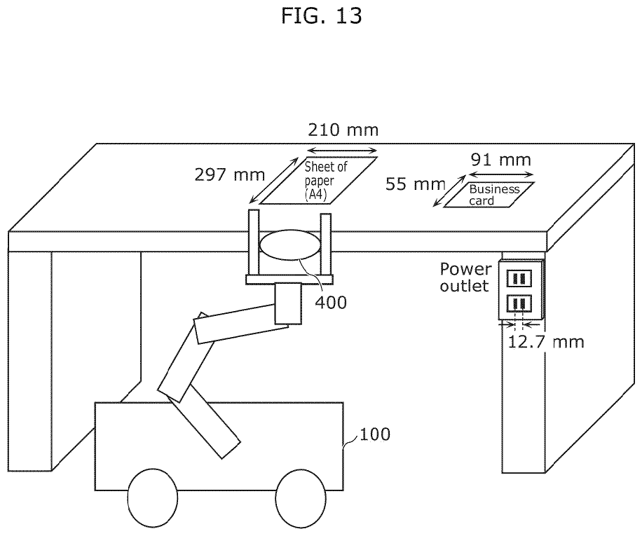

While a description has been given using an example in which object 300 is a pattern image with a checkerboard pattern or the like, object 300 is not limited thereto. The degree of flexibility may be estimated using objects that have a fixed size or whose size falls within a predetermined size range as object 300. Other examples of object 300 will be described with reference to FIGS. 12 and 13.

FIGS. 12 and 13 are diagrams illustrating other examples of object 300 appearing in the background.

As illustrated in FIG. 12, object 300 may be an outdoor pedestrian crossing. In a pedestrian crossing, due to visibility and other reasons, generally, the size of each white line portion is defined as 45 cm×3 m and the intervals between white line portions are defined as 45 cm. The size and the degree of flexibility of target 400 may be estimated using this as background information. For example, FIG. 12 illustrates an example in which robot 100 that is a mobile object or the like moves to a predetermined position in order to use a pedestrian crossing as the background and measures the degree of flexibility by measuring the size of target 400 or applying the force to target 400.

In addition, since contrast between white lines of a pedestrian crossing and the road is vivid, the white lines are straight, and intervals are constant, the pedestrian crossing has an effect of enabling the degree of flexibility to be more accurately estimated from the amount of displacement when the force is applied to target 400.

Furthermore, for example, as illustrated in FIG. 13, objects with a constant size are often present indoors such as a sheet of paper (A4 size), a business card (Japanese size #4:91 mm×55 mm), spacing between holes of a power outlet (A type: 12.7 mm), and a keyboard (not illustrated) (standard pitch is 19 mm). Therefore, object 300 is not limited to a pedestrian crossing and, as illustrated in FIG. 13, the size or the degree of flexibility of target 400 may be estimated by using such objects as object 300 appearing in the background of target 400.

For example, when robot 100 handles target 400 by a remote operation, the size or the degree of flexibility of target 400 may be difficult to recognize from a user at a remote location. In consideration thereof, estimating the size or the degree of flexibility of target 400 by using such object 300 located nearby as the background, the degree of flexibility or the like of target 400 can be estimated in a more quantitative manner.

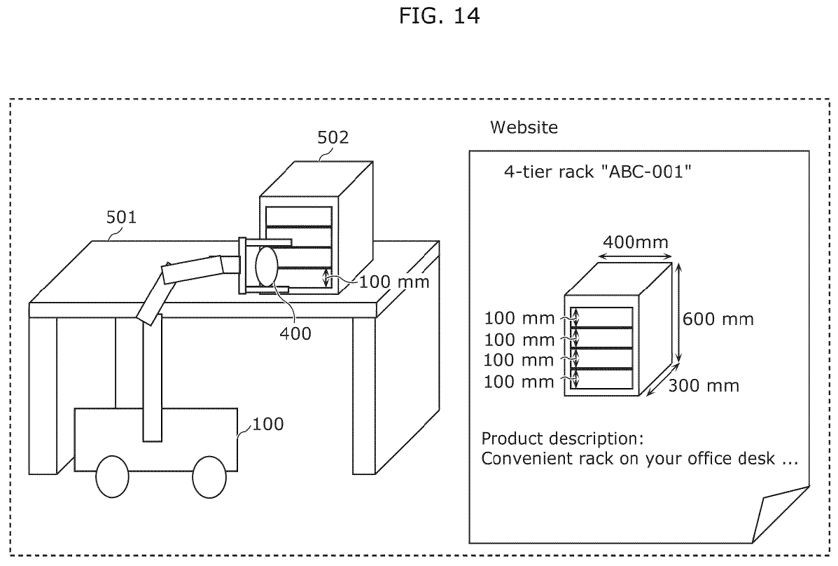

Note that a database of size information or the like of object 300 is not limited to a database accumulated in advance. For example, size information or the like may be searched for via a network, newly obtained, and used. This point will be described with reference to FIG. 14.

FIG. 14 is a diagram for describing the obtaining of size information of object 300 by using a web search.

As illustrated in FIG. 14, for example, 4-tier rack 502 is placed on office desk 501. For example, calculator 40 recognizes rack 502 using an image captured by imager 200, searches for information related to rack 502 on the web, and acquires size information regarding a size of rack 502 using a text analysis technique or the like. In this case, the information describes that rack 502 has a height of 600 mm, a depth of 300 mm, and a width of 400 mm and one tier is 100 mm, and calculator 40 acquires this information as size information. Estimation system 1 uses rack 502 as the background to measure the degree of flexibility or the like of target 400. In this manner, by searching for a background object that is suitable for measurement at each location and obtaining information about the background object, it is possible to more accurately measure the size of target 400 and to accurately estimate the degree of flexibility of target 400 using deformation caused by applying the force.

As described above, estimation system 1 need not store in advance a database of distances between two arbitrary points in object 300 and may acquire size information of arbitrary object 300 via a network.

### Other Embodiments

An embodiment as an example of the technique according to the present disclosure has been described above. However, the technique according to the present disclosure is not limited thereto and can also be applied to embodiments having been modified, substituted, added, omitted, or the like as appropriate. For example, the following modifications are also included in the embodiment of the present disclosure.

While an example in which estimation system 1 includes aligner 20 has been described in the above embodiment, estimation system 1 need not include aligner 20.

While an example in which estimation system 1 includes database 70 indicating a relationship between the amount of deformation and the information on the degree of flexibility has been described in the above embodiment, estimation system 1 need not include database 70.

While an example in which estimation system 1 includes detector 10 has been described in the above embodiment, estimation system 1 need not include detector 10.

For example, the present disclosure can be realized not only as estimation system 1 but also as an estimation method that includes steps (processing) performed by elements constituting estimation system 1.

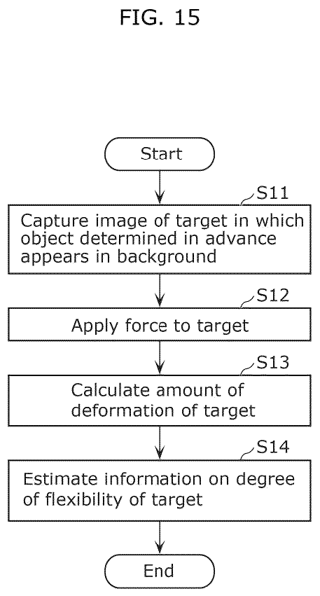

FIG. 15 is a flowchart illustrating an example of an estimation method according to another embodiment.

As illustrated in FIG. 12, the estimation method includes: capturing images of a target in which an object appears in a background (step S11); applying force to the target (step S12); calculating an amount of deformation of the target when the force is applied to the target based on a change in the target with respect to the object in the images captured in the capturing, the change resulting from the force being applied to the target (step S13); and estimating, based on the amount of deformation calculated, information on a degree of flexibility of the target (step S14).

For example, the steps in the estimation method may be executed by a computer (computer system). Moreover, the present disclosure can be implemented as a program for causing a computer to execute the steps included in the estimation method.

In addition, the present disclosure can be implemented as a non-transitory computer-readable recording medium which is a CD-ROM, or the like, having the program recorded thereon.

For example, when the present disclosure is implemented as a program (software), each of the steps is executed by the program being executed using hardware resources such as a CPU, memory, input/output circuit, and so on, of a computer. In other words, each of the steps is executed by way of the CPU obtaining data from the memory, the input/output circuit, or the like, performing mathematical operations, and outputting the result of the mathematical operation to the memory, the input/output circuit, or the like.

Furthermore, each of the elements included in estimation system 1 according to the foregoing embodiments may be implemented as a dedicated or general-purpose circuit.

Furthermore, each of the elements included in estimation system 1 according to the foregoing embodiments may be implemented as a large scale integration (LSI) which is an integrated circuit (IC).

Furthermore, the integrated circuit is not limited to an LSI, and thus may be implemented as a dedicated circuit or a general-purpose processor. Alternatively, a field programmable gate array (FPGA) that allows for programming, or a reconfigurable processor that allows for reconfiguration of the connection and the setting of circuit cells inside an LSI may be employed.

Furthermore, when a circuit integration technology that replaces LSIs comes along owing to advances in semiconductor technology or to a separate derivative technology, the respective elements included in estimation system 1 may understandably be integrated using that technology.

Aside from these, forms obtained through various modifications to the embodiments conceived by those skilled in the art, as well as forms obtained by arbitrarily combining elements and functions in different embodiments, without departing from the essence of the present disclosure are also included in the present disclosure.

### Supplementary Note

The techniques described below are disclosed by the description of the foregoing embodiments.

(Technique 1) An estimation system including: an imager that captures images of a target in which an object appears in a background; an applier that applies force to the target; a calculator that calculates an amount of deformation of the target when the force is applied to the target, based on a change in the target with respect to the object in the images captured by the imager, the change resulting from the force being applied to the target; and an estimator that estimates, based on the amount of deformation calculated, information on a degree of flexibility of the target.

Accordingly, the information on the degree of flexibility of the target can be estimated from the amount of deformation of the target when force is applied to the target, in the images captured by the imager. Specifically, by using the images obtained by capturing images of the target in which the object appears in the background, the amount of deformation of the target can be calculated and information on the degree of flexibility of the target can be estimated without using a tactile sensor by using an image sensor. Since a tactile sensor is not used, cost-reduction becomes possible. In addition, since teaching becomes unnecessary, information on the degree of flexibility of the target can be estimated without teaching.

(Technique 2) The estimation system according to Technique 1, further including: an aligner that aligns an arbitrary point on the target and a reference point on the object, in the images, wherein the calculator calculates the amount of deformation when the force is applied to the target, based on an amount of displacement of the arbitrary point from the reference point in the images, the displacement resulting from the force being applied to the target.

Accordingly, the amount of deformation of the target can be calculated from the amount of displacement of the arbitrary point on the target from the reference point, in the images.

(Technique 3) The estimation system according to Technique 1 or 2, wherein the applier applies the force to the target by gripping the target, shaking the target, rotating the target, tilting the target, or blowing air onto the target.

Accordingly, the target can be deformed by gripping the target, shaking the target, rotating the target, tilting the target, or blowing air onto the target, and the amount of deformation can be calculated.

(Technique 4) The estimation system according to any one of Techniques 1 to 3, wherein the estimator estimates the information on the degree of flexibility of the target by comparing the amount of deformation calculated with a database indicating a relationship between the amount of deformation and the information on the degree of flexibility.

Accordingly, by preparing a database in advance, the information on the degree of flexibility of the target can be easily estimated.

(Technique 5) The estimation system according to any one of Techniques 1 to 4, further including: a detector that detects, as the object, an object that is suitable for calculating the amount of deformation.

Accordingly, by detecting an object, it is possible to capture images of the target in which an object that is suitable for calculating the amount of deformation appears in the background.

(Technique 6) The estimation system according to Technique 5, further including: the detector that detects, as the object, an object that is different in color from the target.

When the color or the target and the color of the object are the same kind of color, the target and the object that appear in the images are hard to distinguish, and thus calculating the amount of deformation of the target becomes difficult. In contrast, when the color or the target and the color of the object are different, the target and the object that appear in the images are easy to distinguish, and thus calculating the amount of deformation of the target becomes easy.

(Technique 7) The estimation system according to any one of Techniques 1 to 6, wherein the estimator estimates the information on the degree of flexibility of the target based on gloss of the target.

Accordingly, since the degree of flexibility of the target can be estimated to some extent according to the gloss of the target, by taking the gloss of the target into consideration, the information on the degree of flexibility of the target can be estimated more accurately.

(Technique 8) The estimation system according to any one of Techniques 1 to 7, wherein the calculator calculates the amount of deformation each time a different method is used to apply force to the target by the applier, and the estimator estimates the information on the degree of flexibility of the target based on the amount of deformation calculated each time a different method is used to apply force to the target by the applier.

Depending on the material of the target, there are cases where the method of applying force is not suitable, and thus the amount of deformation of the target cannot be calculated correctly. However, by calculating the amount of deformation of the object each time the method of applying force to the target is changed, the information on the degree of flexibility of the target can be estimated more accurately.

(Technique 9) The estimation system according to any one of Techniques 1 to 8, wherein the calculator calculates the amount of deformation each time the imager captures an image of the target with a different object appearing in the background, and the estimator estimates the information on the degree of flexibility of the target based on the amount of deformation calculated each time the imager captures an image of the target with a different object appearing in the background.

Depending on the material of the target, there are cases where it is difficult to observe a change in the target relative to the object, and thus the amount of deformation of the target cannot be calculated correctly. However, by calculating the amount of deformation of the object each time the object appearing in the background is changed, the information on the degree of flexibility of the target can be estimated more accurately.

(Technique 10) The estimation system according to any one of Techniques 1 to 9, wherein the calculator calculates the amount of deformation each time the imager captures an image of the target in which a distance between the target and the object is different, and the estimator estimates the information on the degree of flexibility of the target based on the amount of deformation calculated each time the imager captures an image of the target to have a different distance between the target and the object.

Depending on the distance of the target from the object, there are cases where it is difficult to observe a change in the target relative to the object, and thus the amount of deformation of the target cannot be calculated correctly. However, by calculating the amount of deformation of the object each time the distance between the target and the object is changed, the information on the degree of flexibility of the target can be estimated more accurately.

(Technique 11) The estimation system according to any one of Techniques 1 to 10, wherein the information on the degree of flexibility of the target includes the degree of flexibility of the target or a gripping force for gripping the target.

Accordingly, the degree of flexibility of the target or the gripping force for gripping the target can be estimated without teaching.

(Technique 12) The estimation system according to any one of Techniques 1 to 11, wherein the object is a pattern image having a repetitive pattern.

Accordingly, by using images of the target in which a pattern image having a repetitive pattern appears in the background, the amount of deformation of the target can be calculated more accurately.

(Technique 13) The estimation system according to any one of Techniques 1 to 11, wherein the calculator obtains size information of the object via a network.

Accordingly, the amount of deformation of the target can be calculated using an arbitrary object in the vicinity of the target.

(Technique 14) An estimation method including: capturing images of a target in which an object appears in a background; applying force to the target; calculating an amount of deformation of the target when the force is applied to the target, based on a change in the target with respect to the object in the images captured in the capturing, the change resulting from the force being applied to the target; and estimating, based on the amount of deformation calculated, information on a degree of flexibility of the target.

Accordingly, an estimation method capable of estimating information on the degree of flexibility of a target by using an image sensor.

### Industrial Applicability

The present disclosure is applicable to a manipulator, and the like, that grips a pliable object, and so on.

### Reference Signs List

1 estimation system
10 detector
20 aligner
30 applier
40 calculator
50 estimator
60 outputter
70 database
100 robot
110 manipulator
110a table
200 imager
300, 300a, 300b object
400 target
501 office desk
502 rack
P1 reference point
P2 point

1. An estimation system comprising:
an imager that captures images of a target in which an object appears in a background;
an applier that applies force to the target;
a calculator that calculates an amount of deformation of the target when the force is applied to the target, based on a change in the target with respect to the object in the images captured by the imager, the change resulting from the force being applied to the target; and
an estimator that estimates, based on the amount of deformation calculated, information on a degree of flexibility of the target.

2. The estimation system according to claim 1, further comprising:
an aligner that aligns an arbitrary point on the target and a reference point on the object, in the images, wherein
the calculator calculates the amount of deformation when the force is applied to the target, based on an amount of displacement of the arbitrary point from the reference point in the images, the displacement resulting from the force being applied to the target.

3. The estimation system according to claim 1, wherein
the applier applies the force to the target by gripping the target, shaking the target, rotating the target, tilting the target, or blowing air onto the target.

4. The estimation system according to claim 1, wherein
the estimator estimates the information on the degree of flexibility of the target by comparing the amount of deformation calculated with a database indicating a relationship between the amount of deformation and the information on the degree of flexibility.

5. The estimation system according to claim 1, further comprising:
a detector that detects, as the object, an object that is suitable for calculating the amount of deformation.

6. The estimation system according to claim 5, further comprising:
the detector that detects, as the object, an object that is different in color from the target.

7. The estimation system according to claim 1, wherein
the estimator estimates the information on the degree of flexibility of the target based on gloss of the target.

8. The estimation system according to claim 1, wherein
the calculator calculates the amount of deformation each time a different method is used to apply force to the target by the applier, and
the estimator estimates the information on the degree of flexibility of the target based on the amount of deformation calculated each time a different method is used to apply force to the target by the applier.

9. The estimation system according to claim 1, wherein
the calculator calculates the amount of deformation each time the imager captures an image of the target with a different object appearing in the background, and
the estimator estimates the information on the degree of flexibility of the target based on the amount of deformation calculated each time the imager captures an image of the target with a different object appearing in the background.

10. The estimation system according to claim 1, wherein
the calculator calculates the amount of deformation each time the imager captures an image of the target in which a distance between the target and the object is different, and
the estimator estimates the information on the degree of flexibility of the target based on the amount of deformation calculated each time the imager captures an image of the target to have a different distance between the target and the object.

11. The estimation system according to claim 1, wherein
the information on the degree of flexibility of the target includes the degree of flexibility of the target or a gripping force for gripping the target.

12. The estimation system according to claim 1,
wherein
the object is a pattern image having a repetitive pattern.

13. The estimation system according to claim 1,
wherein
the calculator obtains size information of the object via a network.

14. An estimation method comprising:
capturing images of a target in which an object appears in a background;
applying force to the target;
calculating an amount of deformation of the target when the force is applied to the target, based on a change in the target with respect to the object in the images captured in the capturing, the change resulting from the force being applied to the target; and
estimating, based on the amount of deformation calculated, information on a degree of flexibility of the target.
